(19) United States
(12) Patent Application Publication
(10) Pub. No.: US 2013/0070595 A1
(43) Pub. Date: Mar. 21, 2013

(54) Unified Quality of Service Negotiation Method Cross Multi-Media

(71) Applicants: Chia-Wei Yen, Taipei City (TW); JIAN-LI MAO, Suzhou City (CN)

(72) Inventors: Chia-Wei Yen, Taipei City (TW); JIAN-LI MAO, Suzhou City (CN)

(21) Appl. No.: 13/603,435

(22) Filed: Sep. 5, 2012

Related U.S. Application Data
(60) Provisional application No. 61/535,337, filed on Sep. 15, 2011.

(51) Int. Cl. H04L 12/24

(52) U.S. Cl. 370/235

(57) ABSTRACT

A method of unified quality of service, hereafter called QoS, negotiation cross multi-media for a first unified terminal device (UTD) using a first medium for communication in a network system is disclosed. The method comprises obtaining a QoS requirement from the first UTD, via the first medium, transmitting the QoS negotiation request including QoS requirement to a second UTD using a second medium for communication in the network system, and when a QoS negotiation response corresponding to the QoS negotiation request is received from the second UTD, reporting a QoS negotiation result to first UTD according to the QoS negotiation response.

### CROSS REFERENCE TO RELATED APPLICATIONS

This application claims the benefit of U.S. Provisional Application No. 61/535,337, filed on Sep. 15, 2011, entitled “Unified QoS Negotiation Method Cross Multi-Media”, the contents of which are incorporated herein in their entirety.

### BACKGROUND

With rapidly growing of user's needs for accessing digital contents everywhere, various communication technologies have been developed for transmission of the digital contents. These communication technologies may be developed for different environments, different transmission speeds and/or different user requirements. In addition, several medium access control (MAC)/physical (PHY) protocols are established based on different communication standards, which define different communication methods based on heterogeneous mediums. For example, IEEE 1901 communication standard is used for power line (PLC), IEEE 802.11 communication standard is used for wireless communication (i.e. WiFi), IEEE 802.3 communication standard is used for Ethernet, and Multimedia over Coax Alliance (MoCA) communication standard is used for coaxial cables, and so on.

In addition, quality of service (QoS) negotiation is used for resource reservation (i.e. bandwidth reservation) for efficient transmission. Currently, QoS negotiation mechanism is defined in each medium specification (i.e. PLC, WiFi, MoCA, or Ethernet). For example, QoS negotiation in a PLC network is implemented based on the traffic specification (TSPEC). In other words, each QoS negotiation mechanism is well defined according to his specification. There is however no guideline for QoS negotiation cross multi-media. Without clear guideline, communication devices using different media for communication would not know how to perform QoS negotiation with each other. For example, a device A is in WiFi network and a device B is in PLC network. The device A cannot negotiate the QoS requirement with the device B because there is no rule for QoS negotiation cross multi-media.

### SUMMARY

The present invention therefore provides a unified QoS negotiation mechanism cross multi-media, to solve the abovementioned problem.

The present invention discloses a method of unified quality of service, hereafter called QoS, negotiation cross multi-media for a first unified terminal device (UTD) using a first medium for communication in a network system. The method comprises obtaining a QoS requirement from the first UTD, via the first medium, transmitting the QoS negotiation request including QoS requirement to a second UTD using a second medium for communication in the network system, and reporting a QoS negotiation result to the first UTD when a QoS negotiation response corresponding to the QoS negotiation request is received from the second UTD.

The present invention discloses a method of unified quality of service, negotiation cross multi-media for a first unified terminal device (UTD) compatible of at least a medium for communication in a network system. The method comprises via a first medium, receiving a QoS negotiation request including QoS requirement from a second UTD of the network system to a third UTD of the network system, checking whether the QoS requirement is acceptable for the first medium, via a second medium, forwarding the QoS negotiation request to the third UTD when the QoS requirement is acceptable for the first medium, and transmitting a QoS negotiation response failure to the second UTD when the QoS requirement is not acceptable for the first medium.

The present invention discloses a method of unified quality of service, negotiation cross multi-media for a first unified terminal device (UTD) using a first medium for communication in a network system. The method comprises via a first medium, receiving a QoS negotiation request including QoS requirement from a second UTD of the network system, determining whether the QoS requirement is acceptable for the first medium, and transmitting a QoS negotiation response to the second UTD according to the determination.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary unified network system according to the present invention.

FIG. 2 is a schematic diagram of an exemplary communication device according to the present invention.

FIG. 3 is a flowchart of a process according to the present invention.

FIG. 4 is a schematic diagram of a QoS negotiation between devices according to an embodiment.

FIG. 5 is a flowchart of a QoS negotiation process based on FIG. 4.

FIG. 6 is a flowchart of a process according to the present invention.

FIG. 7 is a flowchart of a QoS negotiation process based on FIG. 4.

FIG. 8 is a flowchart of a process according to the present invention.

FIG. 9 is a flowchart of a QoS negotiation process based on FIG. 4.

FIG. 10 is a schematic diagram of a bandwidth reservation of a QoS negotiation between devices according to an embodiment.

FIG. 11 is a schematic diagram of a QoS negotiation signal sequence according to an embodiment.

FIG. 12 is a schematic diagram of a QoS negotiation signal sequence according to an embodiment.

### DETAILED DESCRIPTION

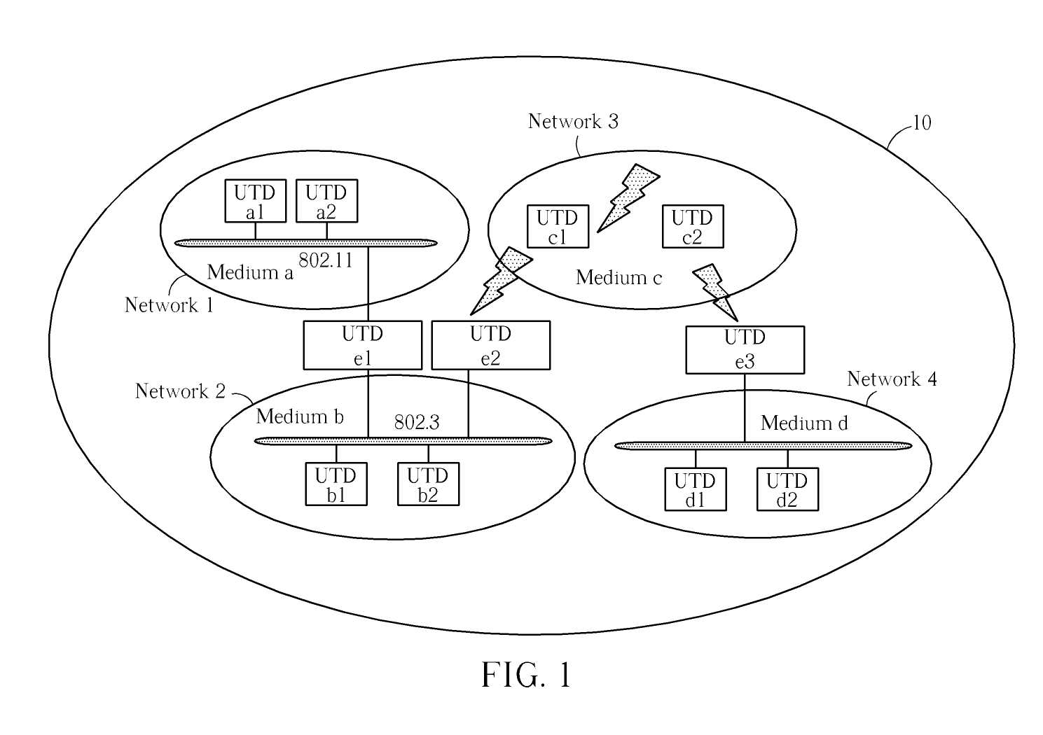

Please refer to FIG. 1, which is a schematic diagram of an exemplary network system 10 according to the present invention. In FIG. 1, the network system 10 includes networks 1-4 each complied with a communication standard, such as IEEE 1901, IEEE 802.11, IEEE 802.3 or Multimedia over Coax Alliance (MoCA). Every communication standard defines a communication method based on a medium. For example, IEEE 1901 is used for power line (PLC), IEEE 802.11 is used for wireless communication (i.e. WiFi), IEEE 802.3 is used for Ethernet, and Multimedia over Coax Alliance (MoCA) is used for coaxial cables. Therefore, unified terminal devices (UTDs) within a network perform communications (i.e. signal reception/transmission) based on a specific medium. For example, in FIG. 1, UTDs a1-a2 within the network 1 communicate with each other via a medium Medium a. UTDs b1-b2 within the network 2 communicate with each other via a medium Medium b, and so on. The UTDs a1-a2, b1-b2, c1-c2, and d1-d2 can be mobile phones, laptops, tablet computers, electronic books, modems, and portable computer systems, etc. Further, network system 10 includes UTDs e1-e3, each compatible of at least two media for cross media communications. For example, the UTD e1 is compatible of media Medium a and b. Thus, the UTD a1 compatible of medium Medium a can communicate with the UTD b1 compatible of medium Medium b through the UTD e1, to implement cross media communication in the network system 10.

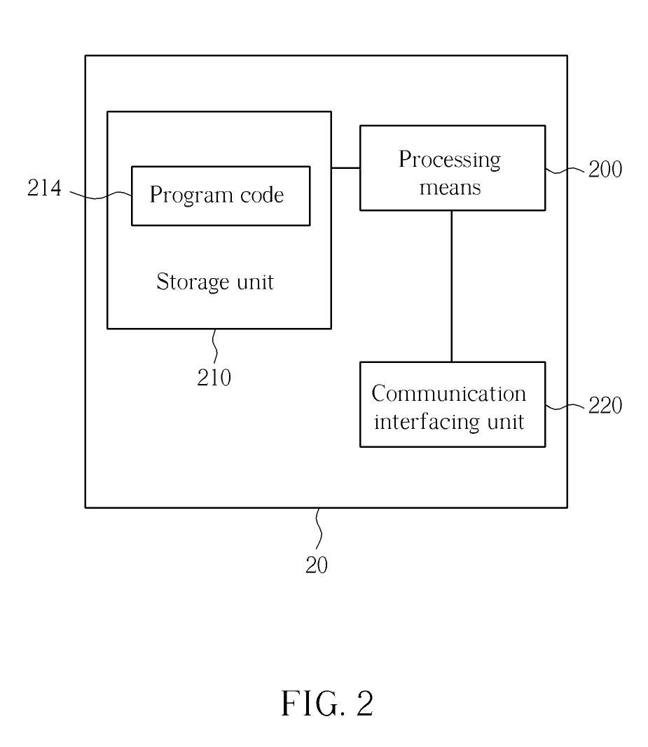

Please refer to FIG. 2, which is a schematic diagram of an exemplary communication device 20 according to the present invention. The communication device 20 can be a unified terminal device shown in FIG. 1. The communication device 20 may include a processor 200 such as a microprocessor or an Application Specific Integrated Circuit (ASIC), a storage unit 210 and a communication interfacing unit 220. The storage unit 210 may be any data storage device that can store a program code 214, accessed by the processor 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a transceiver and can exchange signals with a unified terminal device or the network according to processing results of the processor 200.

Note that, the main idea of the present invention is to provide a user with a unified quality of service (QoS) negotiation experience in multi-media. In other words, the QoS negotiation is performed between unified terminal devices of FIG. 1, wherein each unified terminal devices may use different media for communication in the network system 10.

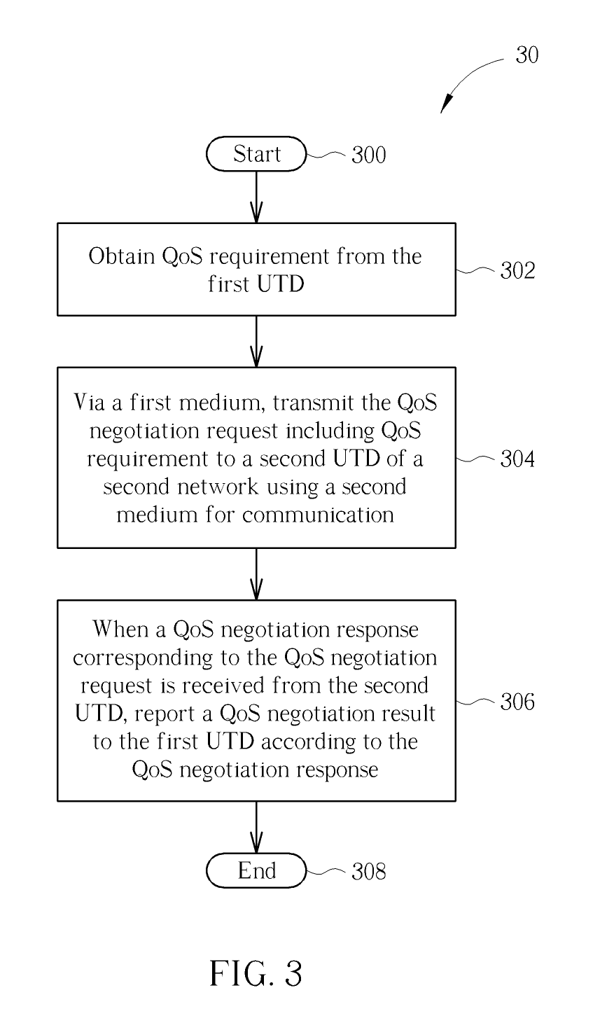

Please refer to FIG. 3, which is a flowchart of a process 30 according to an example of the present invention. The process 30 is utilized in a first UTD of a first network of the network system 10 shown in FIG. 1 for unified QoS negotiation cross multi-media. The process 30 may be compiled into the program code 214 of FIG. 2 and includes the following steps:

Step 300: Start.

Step 302: Obtain a QoS requirement from the first UTD.

Step 304: Via a first medium, transmit the QoS negotiation request including QoS requirement to a second UTD of a second network using a second medium for communication.

Step 306: When a QoS negotiation response corresponding to the QoS negotiation request is received from the second UTD, report a QoS negotiation result to the first UTD according to the QoS negotiation response.

Step 308: End.

According to the process 30, QoS requirement is inputted in a first UTD from a user or upper application. The first UTD sends out the QoS negotiation request to a second UTD compatible of a second medium, with a first medium. If the first UTD receives the QoS negotiation response from the second UTD, the first UTD reports QoS negotiation result to the user or application according to the QoS negotiation response. Based on the process 30, a UTD has the ability to negotiate QoS requirement with another UTD, which uses a medium different with the one that the UTD uses.

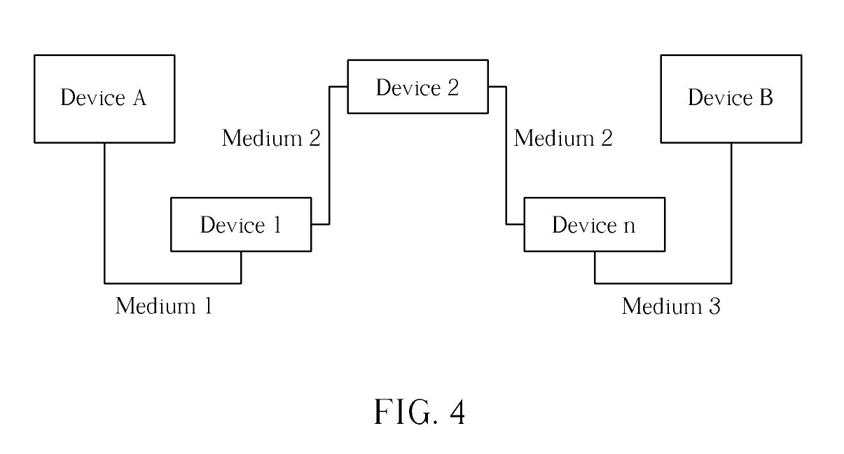

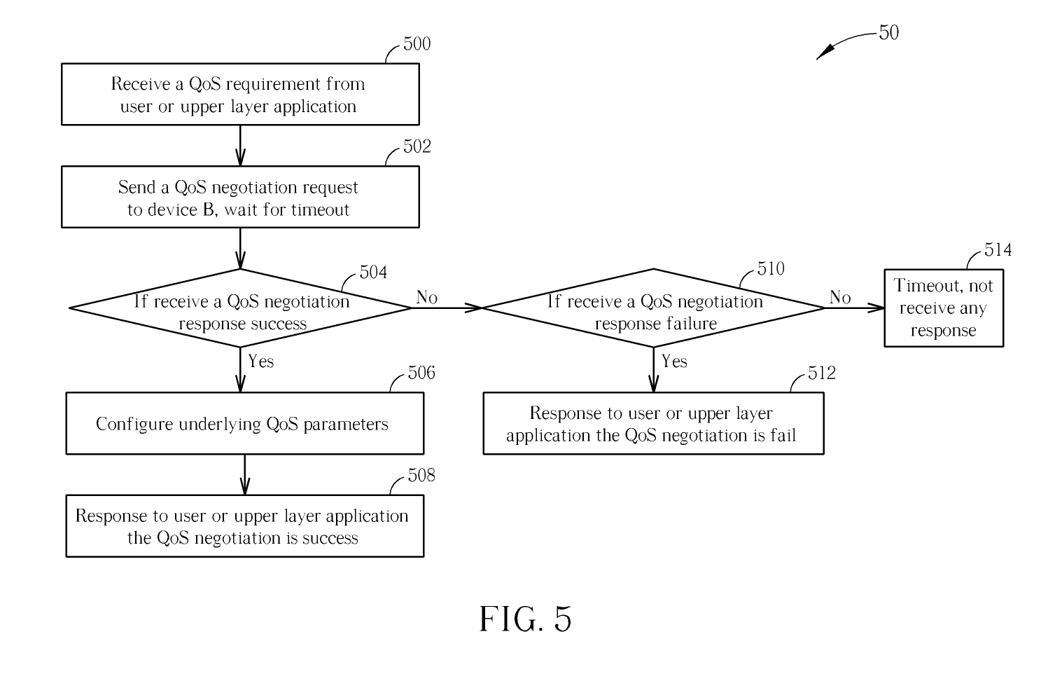

Take an example based on the process 30. Please refer to FIG. 4, which illustrates a QoS negotiation between devices A and B according to an embodiment. The devices A and B may be UTDs shown in FIG. 1. In FIG. 4, the device A and B are on media Medium 1 and 2 respectively, and devices 1, 2, and n are on the data path from the device A to the device B. For example, the device 1 uses media Medium 1 and 2 for communicating with the devices A and 2 respectively, and the device n uses media Medium 2 and 3 for communicating with the devices 2 and B respectively. Further, please refer to FIG. 5, which illustrates QoS negotiation in the device A. First, the device A receives a QoS requirement from a user or upper layer application (in step 500), and sends a QoS negotiation request including the QoS requirement to the device B (in step 502) trough the devices 1, 2, and n. Note that, the device A maintains a timer for reception of a QoS negotiation response corresponding to the QoS negotiation request. If the device A receives a QoS negotiation response success from the device B through the devices 1, 2, and n before expiration of the timer, the device A configures QoS parameters (in steps 504-506). In addition, the device A reports to the user or upper layer application of that the QoS negotiation is successful (in step 508). On the other hand, if the device A receives a negotiation response failure from the device B through the devices 1, 2, and n before expiration of the timer, the device A reports to the user or upper layer application of that the QoS negotiation is failed (in steps 510-512). However, if no QoS negotiation response is received before expiration of the timer, the device A reports to the user or upper layer application of that the QoS negotiation is failed (in steps 512-514).

Based on the above description, a source device, such as the abovementioned device A, has the ability to determine QoS behavior and perform QoS configuration according to the QoS negotiation response. The “source device” herein means that a device requests for a QoS negotiation.

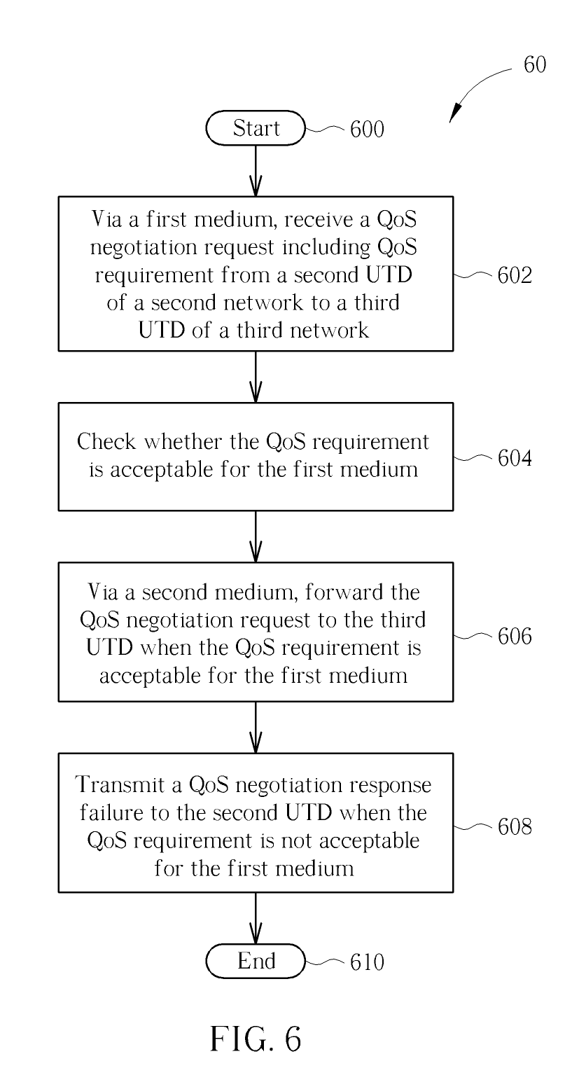

Please refer to FIG. 6, which is a flowchart of a process 60 according to an example of the present invention. The process 60 is utilized in a first UTD of a first network of the network system shown in FIG. 1 for unified QoS negotiation cross multi-media. The process 60 may be compiled into the program code 214 of FIG. 2 and includes the following steps:

Step 600: Start.

Step 602: Via a first medium, receive a QoS negotiation request including QoS requirement from a second UTD of a second network to a third UTD of a third network.

Step 604: Check whether the QoS requirement is acceptable for the first medium.

Step 606: Via a second medium, forward the QoS negotiation request to the third UTD when the QoS requirement is acceptable for the first medium.

Step 608: Transmit a QoS negotiation response failure to the second UTD when the QoS requirement is not acceptable for the first medium.

Step 610: End.

According to the process 60, a first UTD checks if it can fulfill the QoS requirement in the QoS negotiation request with the first medium when receiving the QoS negotiation request from a second UTD to a third UTD. The first UTD transmits the QoS negotiation response failure to the second UTD when determining that the QoS requirement is not acceptable for the first medium. On the other hand, the first UTD forwards the QoS negotiation request to the third UTD when determining that the QoS requirement is acceptable for the first medium.

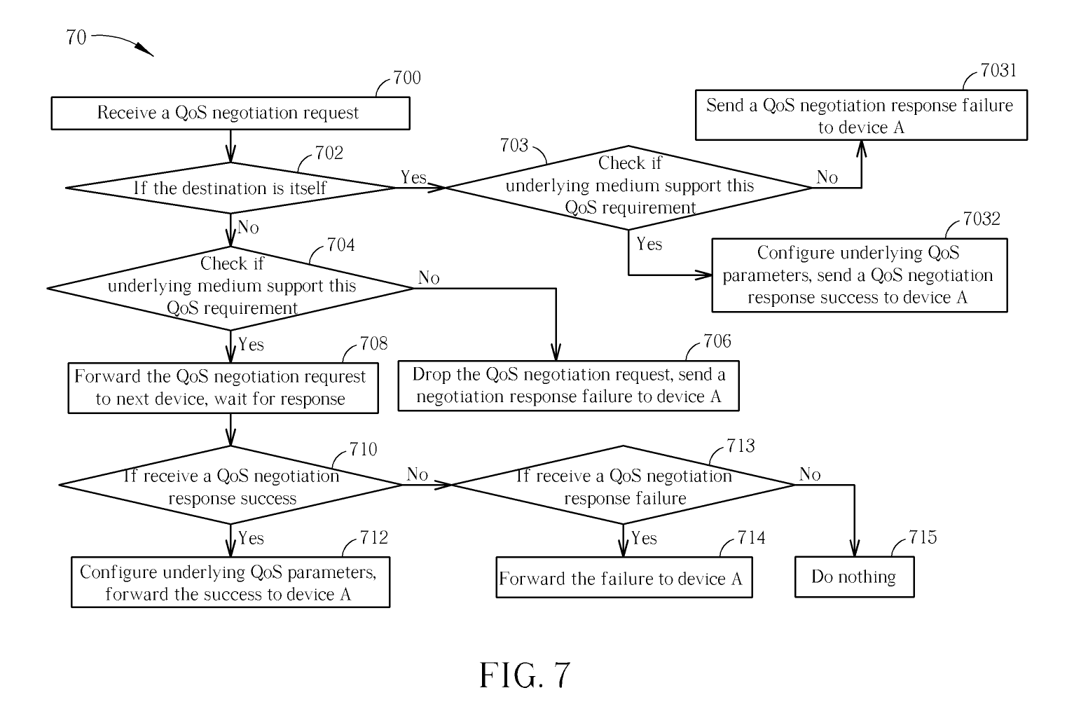

Take an example based on the process 60. Referring back to FIG. 4, the process 60 can be applied in the devices 1, 2, and n of FIG. 4. For detailed operation of the devices 1, 2, and n, please refer to FIG. 7, which illustrates QoS negotiation in the device 1, 2 and n. The device 1 receives a QoS negotiation request including QoS requirement from the device A with the medium Medium 1 (in step 700). The device 1 determines whether a destination of the negotiation request is itself (in step 702). If device 1 determines that it is the destination of the negotiation request, the device 1 checks whether the QoS requirement is acceptable for the medium Medium 1 (in step 703). If the QoS requirement is not acceptable for the medium Medium 1, the device 1 transmits a QoS negotiation response failure to the device A (in step 7031). If the QoS requirement is acceptable for the medium Medium 1, the device 1 transmits a QoS negotiation response success to the device A, and configures QoS parameters (in step 7032).

Note that, if the device 1 determines that it is not the destination of the negotiation request, the device 1 checks whether the QoS requirement is acceptable for the medium Medium 1 (in step 704). If the QoS requirement is not acceptable for the medium Medium 1, the device 1 drops the QoS negotiation request and responses a QoS negotiation response failure to the device A (in step 706). On the other hand, if the QoS requirement is acceptable for the medium Medium 1, the device 1 forwards the QoS negotiation request to the device 2 via the medium Medium 2 and waits for a QoS negotiation response from the destination device B (in step 708). If the devices 1 receives a QoS negotiation response success from the device B (i.e. through the devices 2 and n), the device 1 forwards the QoS negotiation response success to the device A, and configuring QoS parameters (in steps 710-712), whereas if the device 1 receives QoS negotiation response failure from the device B, the device 1 forwards the QoS negotiation response failure to the device A (in steps 713-714). Besides, if the device 1 receives no QoS negotiation response from the device B, the device 1 does nothing (in step 715). Note that, steps 700-715 can be applied in any device (i.e. devices 1, 2 and n), which is in a data path between device A and B. The detailed operation for the devices 2 and n can be referred from above, so it is omitted herein.

Based on the above description, a device between the source device and destination device, such as the abovementioned devices 1, 2, and n, has the ability to determine QoS behavior and perform QoS configuration according to the QoS negotiation response from the destination device or the medium capability. The “destination device” herein means a device which the source device wants to perform QoS negotiation with.

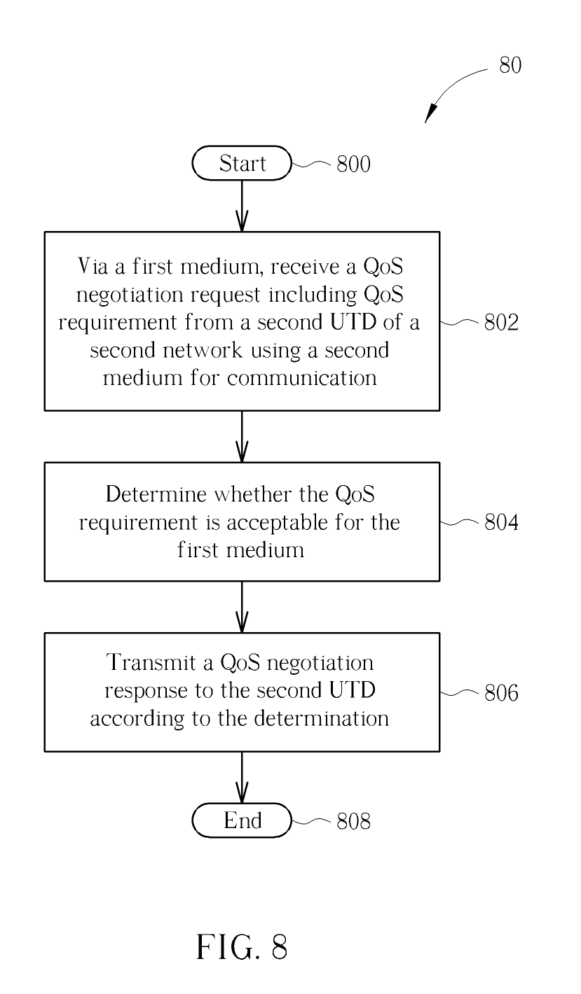

Please refer to FIG. 8, which is a flowchart of a process 80 according to an example of the present invention. The process 80 is utilized in a first UTD of a first network of the network system shown in FIG. 1 for unified QoS negotiation cross multi-media. The process 30 may be compiled into the program code 214 of FIG. 2 and includes the following steps:

Step 800: Start.

Step 802: Via a first medium, receive a QoS negotiation request including QoS requirement from a second UTD of a second network using a second medium for communication.

Step 804: Determine whether the QoS requirement is acceptable for the first medium.

Step 806: Transmit a QoS negotiation response to the second UTD according to the determination.

Step 808: End.

According to the process 80, the first UTD receives the QoS negotiation request including QoS requirement from a second UTD, and checks if it can support this QoS requirement. In addition, the first UTD transmit the QoS negotiation response (e.g. a QoS negotiation response success or QoS negotiation response failure) to the second UTD based on the determination of whether the first medium supports the QoS requirement.

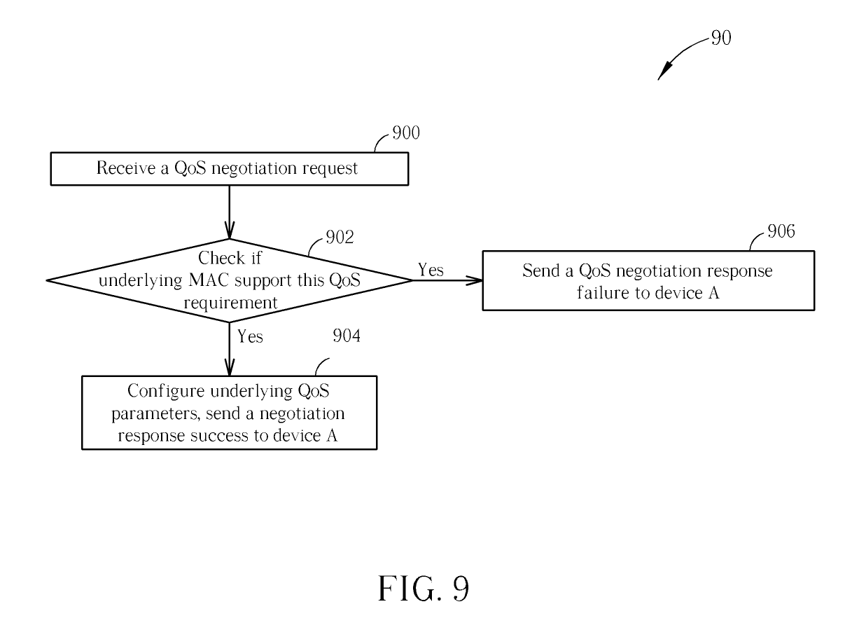

Take an example based on the process 80. Referring back to FIG. 4, the process 80 can be applied in the device B of FIG. 4. For detailed operation of the device B, please refer to FIG. 9, which illustrates QoS negotiation in the device B. The device B receives a QoS negotiation request including QoS requirement from the device n with the medium Medium 3 (in step 900). After that, the device B checks whether the QoS requirement is acceptable for the medium Medium 3 (in step 902). If the QoS requirement is not acceptable for the medium Medium 3, the device B responses the QoS negotiation response failure to the device A (in step 906). On the other hand, if the QoS requirement is acceptable for the medium Medium 3, the device B responses the QoS negotiation response success to the device A, and configures QoS parameters (in step 904).

Based on the above description, a destination device, such as the abovementioned device B, has the ability to determine QoS behavior and perform QoS configuration according to the medium capability.

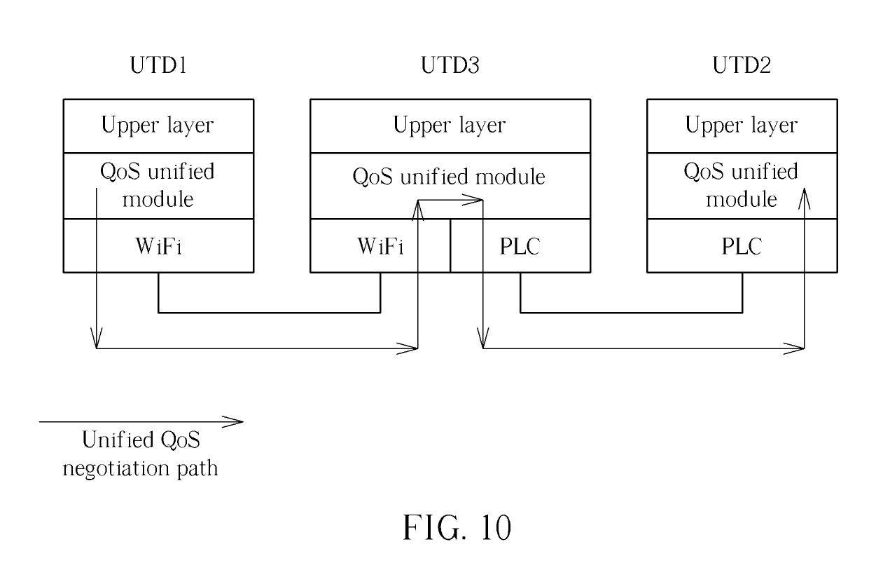

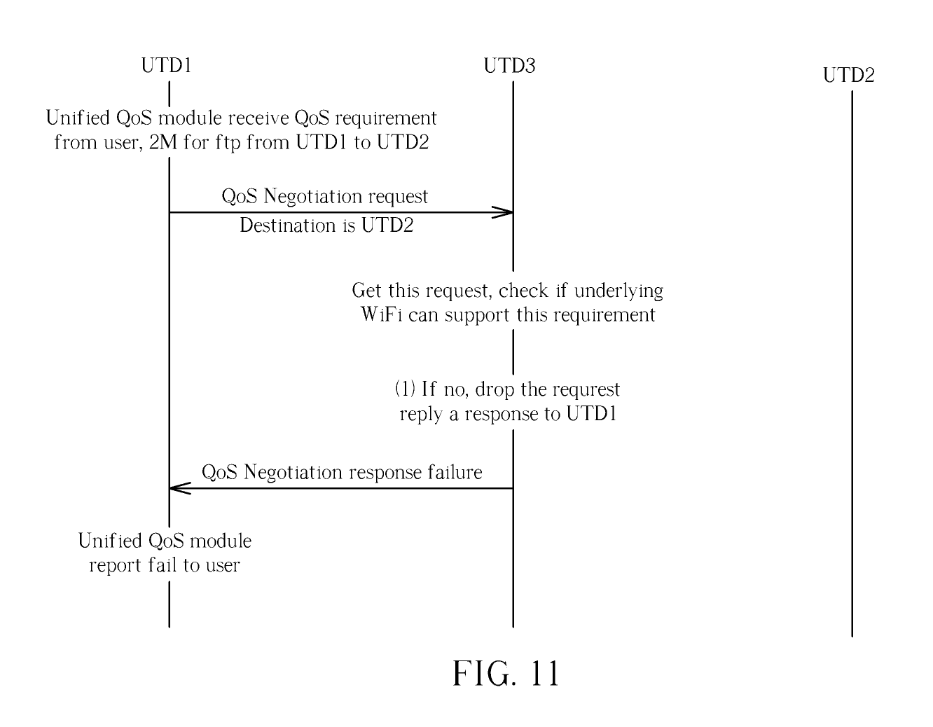

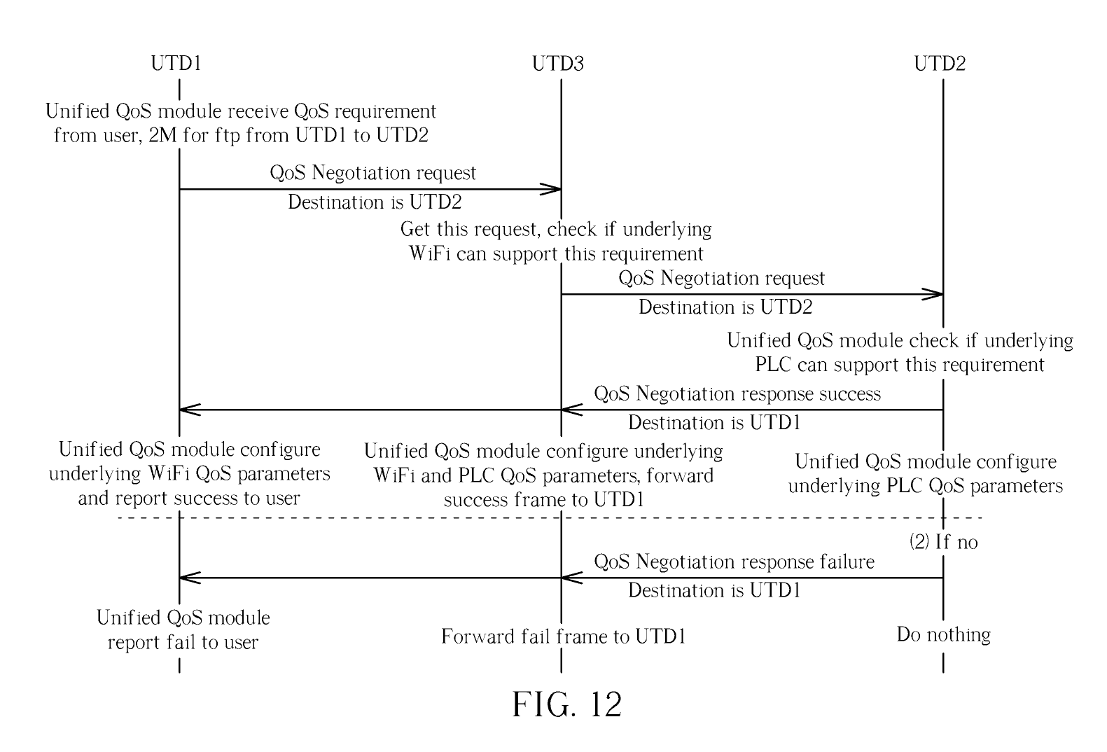

Further, take a bandwidth reservation of QoS negotiation as an example. Please refer to FIG. 10, which illustrates a unified QoS negotiation path. A user wants to reserve 2M bandwidth for ftp data transmission between a UTD1 and UTD2, where UTD3 is in the data path from the UTD1 to UTD2. In FIG. 10, the UTD1 uses WiFi for communication, the UTD2 uses PLC for communication, and the UTD 3 is capable of using WiFi and PLC for communication. In this situation, the user inputs QoS requirement (i.e. 2M bandwidth ftp transmission) in the UTD1, and thereby the UTD1 sends the QoS requirement to the UTD2 through the UTD3. Note that, the UTD1, UTD3 and UTD 2 shall follow the principle as taught in the processes 30, 60, 80 respectively. Further, please refer to FIGS. 11 and 12, wherein FIG. 11 illustrates a QoS negotiation signal sequence according to an embodiment, and FIG. 12 illustrates a QoS negotiation signal sequence according to another embodiment. In FIG. 11, a unified QoS module of the UTD1 receives QoS requirement (i.e. 2M bandwidth for ftp from UTD1 to UTD2) from the user. The UTD1 transmits QoS negotiation request to the UTD3. Then, the UTD3 gets the QoS requirement from the QoS negotiation request. The UTD3 checks if underlying WiFi can support this QoS requirement. If QoS requirement is not supported by the underlying WiFi of the UTD3, the UTD3 drops the QoS negotiation request and replies QoS negotiation response failure to the UTD1. Thus, the unified QoS module of UTD1 reports QoS negotiation failure to the user.

The difference between FIG. 11 and FIG. 12 is that the QoS requirement is supported by the underlying WiFi of the UTD3. Then, the UTD3 forwards the QoS negotiation request to the UTD2. After the UTD 2 receives the QoS negotiation request, the unified QoS module of the UTD2 checks if underlying PLC can support the QoS requirement in the QoS negotiation request. If QoS requirement is supported by the underlying PLC of the UTD2, the UTD2 replies QoS negotiation response success to the UTD3, and the unified QoS module of the UTD2 configures the underlying PLC of QoS parameters. In addition, after the UTD3 receives the QoS negotiation response success from the UTD2, the unified QoS module of the UTD3 configures the underlying WiFi and PLC of QoS parameters. Further, the UTD3 forwards the received QoS negotiation response success to the UTD1. Then, the unified QoS module of UTD1 configures the underlying WiFi of QoS parameters, and reports QoS negotiation success to the user.

On the other hand, if QoS requirement is not supported by the underlying PLC of the UTD2, the UTD2 replies QoS negotiation response failure to the UTD3, and the unified QoS module of the UTD2 does not configures the underlying PLC of QoS parameters. In addition, after the UTD3 receives the QoS negotiation response failure from the UTD2, the UTD3 forwards the received QoS negotiation response failure to the UTD1. Then, the unified QoS module of UTD1 reports QoS negotiation failure to the user.

Please note that, the abovementioned steps of the processes including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

To sum up, the present invention provides a method of unified QoS negotiation cross multi-media. Thus, devices using different media know how to perform QoS negotiation, to provide a user of unified experience within QoS negotiation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of unified quality of service (QoS) negotiation cross multi-media for a first unified terminal device (UTD) using a first medium for communication in a network system, the method comprising:
obtaining a QoS requirement from the first UTD;
via the first medium, transmitting a QoS negotiation request including the QoS requirement to a second UTD using a second medium for communication in the network system; and
when a QoS negotiation response corresponding to the QoS negotiation request is received from the second UTD, reporting a QoS negotiation result to the first UTD according to the QoS negotiation response.

2. The method of claim 1, wherein when the QoS negotiation response corresponding to the QoS negotiation request is received from the second UTD, reporting the QoS negotiation result to the first UTD according to the QoS negotiation response comprises:
when a QoS negotiation response success of the QoS negotiation response is received from the second UTD, reporting to the user or application the QoS negotiation is successful; and
when the QoS negotiation response failure of the QoS negotiation response is received from the second UTD, reporting to the user or application the QoS negotiation is failed.

3. The method of claim 1, further comprising:
configuring QoS parameters of the first UTD when a QoS negotiation response success of the QoS negotiation response is received from the second UTD.

4. The method of claim 1, further comprising:
when no QoS negotiation response is received from the second UTD during a period of time, reporting to the user or the application the QoS negotiation is failed.

5. A method of unified quality of service, hereafter called QoS, negotiation cross multi-media for a first unified terminal device (UTD) compatible of at least a medium for communication in a network system, the method comprising:
via a first medium of the at least a medium, receiving a QoS negotiation request including QoS requirement from a second UTD of the network system to a third UTD of the network system;
checking whether the QoS requirement is acceptable for the first medium;
via second medium of the at least a medium, forwarding the QoS negotiation request to the third UTD when the QoS requirement is acceptable for the first medium; and
transmitting a QoS negotiation response failure to the second UTD when the QoS requirement is not acceptable for the first medium.

6. The method of claim 5, further comprising:
receiving a QoS negotiation response corresponding to the QoS negotiation request, from the third UTD; and
forwarding a QoS negotiation result to the second UTD according to the QoS negotiation response.

7. The method of claim 6, wherein receiving the QoS negotiation response from the third UTD comprises:
receiving a QoS negotiation response success of the QoS negotiation response from the third UTD when the QoS requirement is acceptable for the second medium; and
receiving a QoS negotiation response failure of the QoS negotiation response from the third UTD when the QoS requirement is not acceptable for the second medium.

8. The method of claim 6, wherein forwarding the QoS negotiation result to the second UTD according to the QoS negotiation response comprises:
forwarding the QoS negotiation response success to the second UTD when the QoS negotiation response success is received; and
forwarding the QoS negotiation response failure to the second UTD when the QoS negotiation response failure is received.

9. The method of claim 7, further comprising:
configuring QoS parameters of the first UTD when the QoS negotiation response success is received.

10. A method of unified quality of service, hereafter called QoS, negotiation cross multi-media for a first unified terminal device (UTD) using a first medium for communication in a network system, the method comprising:
via a first medium, receiving a QoS negotiation request including QoS requirement from a second UTD of the network system;
determining whether the QoS requirement is acceptable for the first medium; and
transmitting a QoS negotiation response to the second UTD according to the determination.

11. The method of claim 10, wherein transmitting the QoS negotiation response to the second UTD according to the determination comprises:
transmitting a QoS negotiation response failure of the QoS negotiation response to the second UTD when determining the QoS requirement is not acceptable for the first medium; and
transmitting a QoS negotiation response success of the QoS negotiation response to the second UTD when determining the QoS requirement is acceptable for the first medium.

12. The method of claim 11, further comprising:
configuring QoS parameters of the first UTD when determining the QoS requirement is acceptable for the first medium.
